(19) United States
(12) Patent Application Publication
(10) Pub. No.: US 2022/0092534 A1
(43) Pub. Date: Mar. 24, 2022

(54) EVENT-BASED RISK ASSESSMENT

(71) Applicant: International Business Machines Corporation, Armonk, NY (US)

(72) Inventors: Mohan Nagraj Dani, Bangalore (IN); Balaji Rishi Sundarajan, Hyderabad (IN); Sharath C. Athrey, Bangalore (IN)

(21) Appl. No.: 17/026,148

(22) Filed: Sep. 18, 2020

(51) Int. Cl. G06Q 10/08; G06Q 10/06; G06N 5/04

(52) U.S. Cl. CPC G06Q 10/0835; G06N 5/04; G06Q 10/0635

(57) ABSTRACT

A plurality of liability events of an asset is identified. The plurality of liability events impacts an economic liability of the asset. Different subsets of the plurality of liability events chain together in different causal timelines of the asset. A group of liability events to exclude from analysis is identified based on a likelihood of the group of liability events impacting the economic liability being lower than a threshold. Remaining liability events are analyzed. A causal timeline of liability events that has a least amount of economic liability is identified via the analysis.

### BACKGROUND

Many factors may be used to determine an overall value and/or liability of an asset. For example, an asset could be a thing that could be bought, invested in, insured, or the like. An organization may desire to acquire one of these assets (such as by purchasing the asset, investing in the asset, insuring the asset, etc.) and/or plan a strategy for one of these assets (such as by planning a route where the asset is a shipping voyage or other type of venture with a desired and structured end-point with many varying way in which one can achieve that end-point), and may therefore have a desire to evaluate values and/or liabilities imparted by various factors. Some of these factors may relate to specific events in time, whether past events, ongoing events, or future events. However, it may be an extremely difficult and nuanced evaluation to weigh each of the factors and/or events to determine a true value and/or risk of an asset. For example, an asset may have dozens of factors that correspond into dozens of historical and/or potential events of varying magnitudes that interrelate in different ways to have different impacts upon a value and/or liability of an asset.

### SUMMARY

Aspects of the present disclosure relate to a method, system, and computer program product relating to evaluating a liability of an asset by analyzing different causal timelines that include different liability events. For example, the method includes identifying a plurality of liability events of an asset. The plurality of liability events impacts an economic liability of the asset. Different subsets of the plurality of liability events chain together in different causal timelines of the asset. The method also includes identifying a group of liability events to exclude from analysis based on a likelihood of the group of liability events impacting the economic liability being lower than a threshold. The method also includes analyzing the remaining liability events. The method also includes identifying, from the analysis, a causal timeline of liability events that has a least amount of economic liability. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of one embodiment of a computing environment in which a controller determines a liability of an asset by evaluating liability events of causal timelines and eliminating a portion of at least one or more causal timelines.

FIG. 2A depicts a conceptual diagram of a polynomial lattice of causal timelines of liability events of an asset that branch from a single starting point.

FIG. 2B depicts a conceptual diagram of a polynomial lattice of causal timelines of liability events of an asset that branch from a single starting point and end with a single termination point.

FIG. 3 depicts a conceptual box diagram of one embodiment of the controller of FIG. 1.

FIG. 4 depicts a flowchart of one embodiment of an example method of evaluating a liability of an asset by evaluating various causal timelines of liability events of the asset and eliminating at least part of one causal timeline.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to evaluating assets, while more particular aspects of the present disclosure relate to determining liability events of a causal timeline that may be excluded in evaluating liability of an asset via an analysis of the remaining liability events. While the present disclosure is not necessarily limited to such applications, various aspects of the disclosure may be appreciated through a discussion of various examples using this context.

A person or organization may want to acquire an asset. For example, a person or organization may way to purchase an asset that can be owned, invest in an asset over a period of time, insure an asset, route a shipping vessel from an origin to a destination, or the like. As used herein, “acquiring an asset” may relate to an action in which a person gains some economic stake in the asset. For example, an asset may include a collateralized debt obligation (CDO) of a plurality of mortgages that a person is considering investing in, such that a user must consider a risk of the CDO (and therein a risk of some or all of the mortgages, each of which have a plurality of events that can impact the risk of the mortgage) before deciding to acquiring a stake in the CDO. For another example, an asset may include a business loan (where the organization is the bank, and liability events may include known past events and/or potential future events that make it more or less likely that the business loan will be repaid).

Additionally, or alternatively, a person or organization may want to plan a future strategy for an asset. For example, the asset may be a shipping voyage between an origin and a destination. In this example, the person or organization may want to plan a route between the origin and destination based on a potential for various liability events to occur. These liability events include potential occurrences that make it more or less likely that the shipping voyage will arrive on time with all of the goods undamaged. For example, liability events of a shipping voyage may include potential weather events, potential delays at port, potential human-initiated events (e.g., seizures by a hostile entity or being stopped for customs), or the like.

Before acquiring and/or planning a future strategy for an asset, a person or organization may want to identify a risk and value of the asset. In some cases, it may be relatively easy to find out a value of the asset, but it may be relatively difficult to determine the risk of acquiring an asset and/or a risk for future strategy of an asset. For example, there may be a great multitude of known past events, current ongoing events, and/or future probable/certain events that impact a liability of an asset, and these factors may interrelate in unexpected and unpredictable ways.

As such, even with current conventional asset acquisition tools and/or asset strategizing tools that aid in cataloguing various risk events, it may be difficult for a person to identify which assets are worth acquiring in a quick timeframe and/or identify how to plan for an asset in a quick timeframe. Rather, it may require the assistance of a highly trained and specialized analyst that is specifically trained that analyze each of the different asset categories, and this analyst may need to look at and consider each liability event that is catalogued within the conventional asset acquisition and/or strategizing tool. Further, in some examples an asset may be included in a plurality of sub-assets that themselves all include liability events, such as the aforementioned CDO of a plurality of mortgages. Each of these may have myriad liability events that impact liabilities, such as historical liability events (e.g., crime, historical credit scores, interest rates), current ongoing liability events (e.g., current geopolitical considerations), future liability events (e.g., future weather events) that may relate to the asset itself (e.g., terms or conditions of a loan), a borrower behind the asset (e.g., an income-to-debt ratio of a person asking for a loan), any natural hazards that may relate to the asset (e.g., wildfires/earthquakes/tornadoes that relate to a location associated with the asset, or pandemics that are in an area associated with the asset), or the like.

Aspects of this disclosure relate to systems and methods that evaluate a liability of an asset via an analysis of liability events of the asset that excludes some liability events of the asset. Analyzing a liability of an asset via liability events may improve an ability of a system to have concrete factors to find correlations between, and excluding some liability events may improve an ability of a system to execute this analysis more efficiently (e.g., such that aspects of this disclosure may reduce an amount of processing power and/or time that is required to analyze a liability of an asset).

One or more computing controllers that include one or more processors executing instructions stored on one or more computing memories (these computing controllers discussed generically herein as a single computing controller) may execute such a liability analysis of an asset. A controller may execute this liability analysis via evaluating causal timelines of liability events with little or no help from a trained user. For example, a controller may gather liability event data related to an asset from one or more sources, determine a polynomial lattice that reflect a causal timeline of these liability events, determine some liability events that may be excluded, and then analyze the liability of this modified polynomial lattice that uniquely identifies and quantifies these liability events.

The controller may analyze the generated and modified polynomial lattice by comparing the generated and modified polynomial lattice against a corpus of hundreds or thousands (or more) of causal timelines for historical assets, where many of these stored causal timelines of the corpus have associated liability values and asset values. The controller may use a neural network or the like to evaluate comparisons between causal timelines using unsupervised clustering techniques. The controller may be faster and more accurate than either a trained analyst or a conventional system (e.g., a conventional system that is configured to quantify every single identified liability event) at identifying correlations between the stored causal timelines and the modified polynomial lattice that purposefully excludes some known liability events isolated liability factors.

When generating the polynomial lattice, the controller may cluster similar liability events together on one or more branches, where liability events extend out along a branch as they extend further back into time or further forward into time. For example, the controller may include a first branch with liability events of weather, a second branch with liability events of crime, a third branch with liability events of industry type, or the like. In such instances, when the controller identifies that one liability event is predicted to be low-impact and can therefore be excluded from analysis, the controller may also exclude all other liability events that are “further down” this same branch, as these liability events are expected to be excludable for the same reason. By clustering liability events of a similar type onto shared branches, the controller may increase an ability to identify liability events that can be excluded to reduce a computational requirement of analysis while maintaining a high accuracy of the analysis.

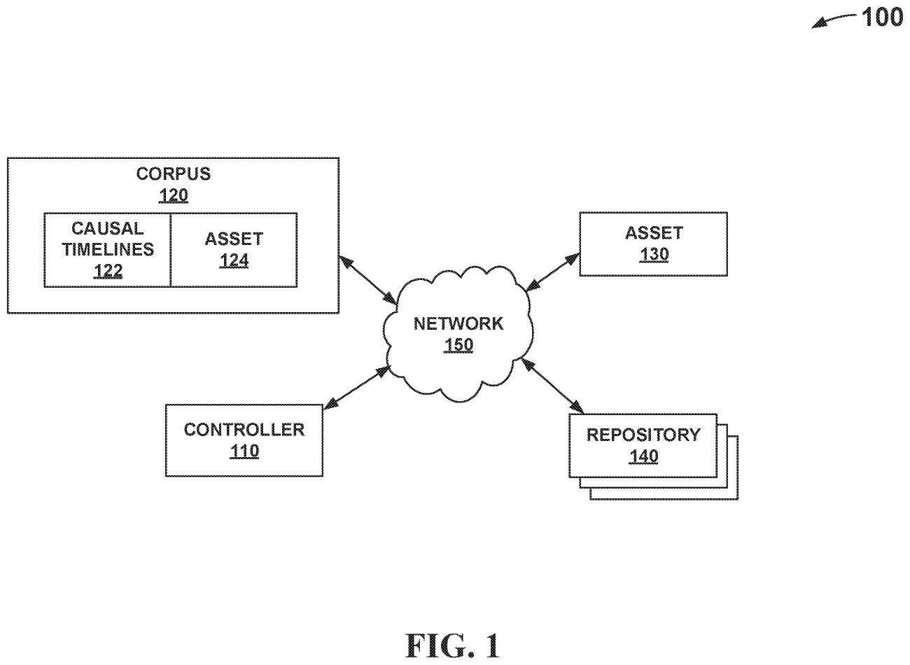

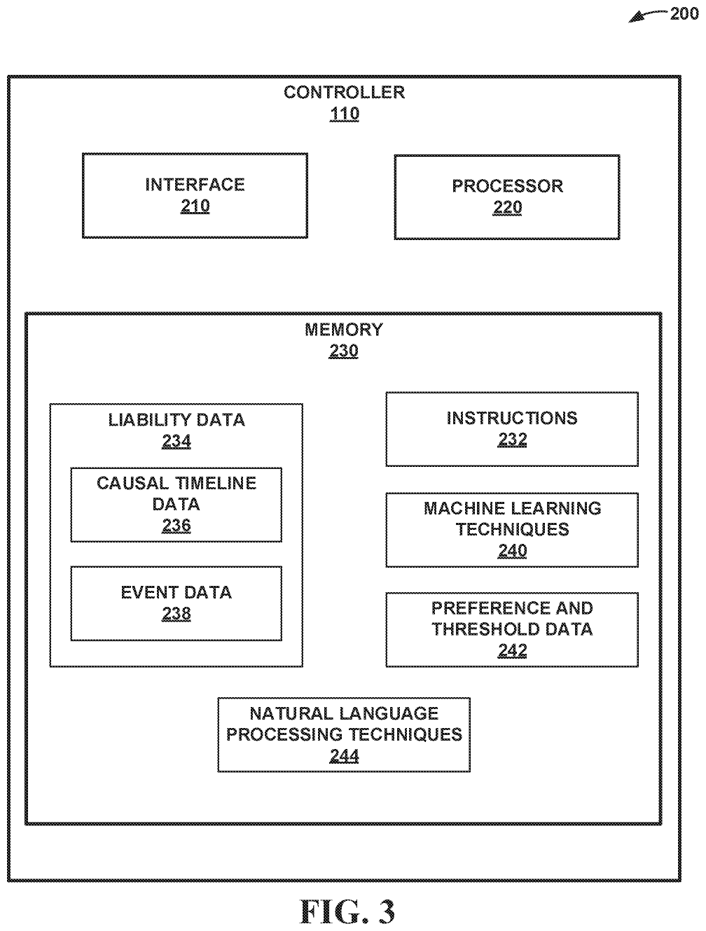

For example, FIG. 1 depicts environment 100 that includes controller 110 that is configured to analyze an economic liability of asset 130 using causal timelines that excludes a group of liability events. Controller 110 may include a computing device, such as computing device 200 of FIG. 3 that includes a processor communicatively coupled to a memory that includes instructions that, when executed by the processor, cause controller 110 to execute the operations described below.

Controller 110 may identify liability events of asset 130. In some examples, controller 110 may identify liability events in response to receiving a request from a user device (not depicted) to analyze a liability of asset 130. As discussed herein, asset 130 may be a thing that an organization may acquire (e.g., monetize an involvement in) and/or plan a future strategy of. For example, asset 130 may be a business venture that involves successful execution of a predetermined task, where liability events include future occurrences that might make it more or less difficult to successfully execute the business venture (e.g., where the business venture is a shipping voyage and the liability events include inclement weather). In this example, controller 110 may identify various sets of liability events (and respective likelihoods and potential repercussions) depending upon what strategy a business takes to execute this task (e.g., what route a shipping voyage takes across an ocean). For another example, asset 130 may include a thing such as a CDO that a business may acquire, where liability events include past, current, or potential future liability events that may impact a likelihood of monetizing asset 130.

In some examples, controller 110 may receive information regarding liability events of asset 130 in a single message. For example, controller 110 may receive a single message that includes a form with asset 130 and liability data, from which controller 110 may identify all of the relevant liability events. In other examples, controller 110 may crawl across one or more repositories 140 to gather liability data. For example, controller 110 may receive a request relating to asset 130 that indicate a business, with which controller 110 utilizes a credit score repository 140 to determine a credit score that is associated with the business. Similarly, if controller 110 receives a request relating to asset 130 of shipping voyage across a particular shipping route, controller 110 may gather data relating to weather and incident reports from respective repositories 140 on these subjects. Controller 110 may use natural language processing (NLP) techniques as known in the art and discussed herein to ingest this data once discovered.

Once controller 110 gathers this data (and therein identify a plurality of liability events from it), controller 110 may organize liability events into causal timelines for asset 130. Causal timelines may include any number of liability events. A given liability event can be on only one causal timeline (e.g., where asset 130 is a shipping voyage and a causal timeline includes a potential route and liability event includes something that is unique to that route), or liability events can be on a plurality of causal timelines. In some examples, liability events can be on many different causal timelines with different associated degrees of magnitude, such that a likelihood of occurrence of a liability event is more likely on some causal timelines than on other causal timelines. For example, where asset 130 is a shipping voyage, a liability event of rough seas may be present on most causal timelines, but may have substantially higher or lower likelihood for different routes.

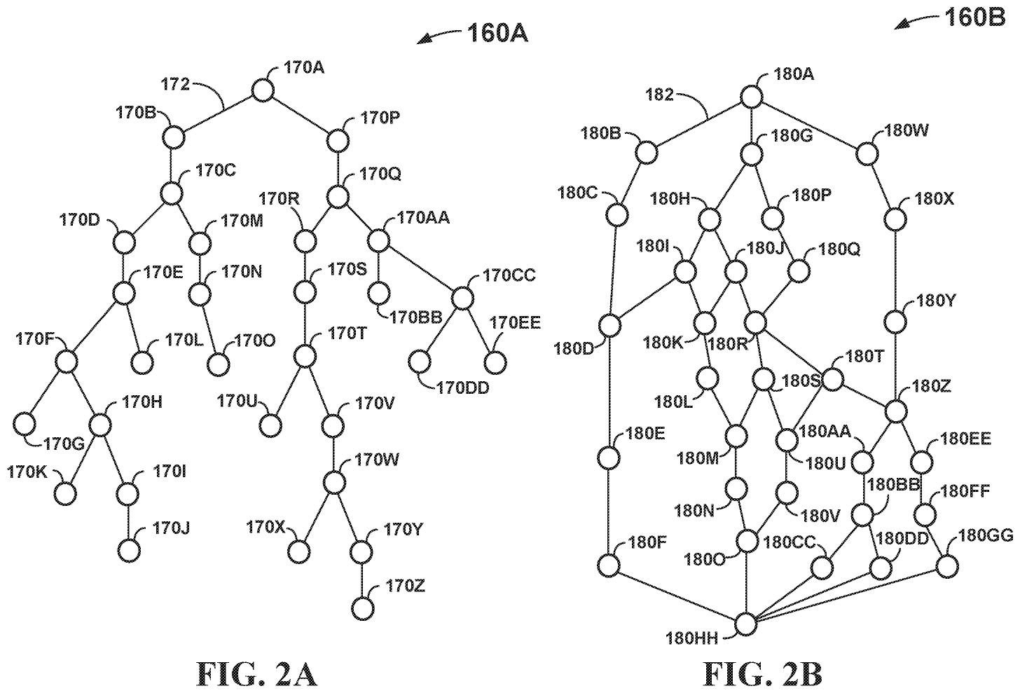

Causal timelines may include a structure of liability events, wherein an order of liability events (this order referred to herein as a “chain”) indicates meaning. For example, controller 110 may generate a polynomial lattice (e.g., such as polynomial lattices 160A, 160B of FIGS. 2A and 2B) in which an order of respective liability events within a chain indicates meaning. This meaning may indicate a relative timeline, where a first liability event preceding a second liability event in an order indicates that the first liability event did/will/is predicted to potentially occur prior to the second liability event. In some examples, a first liability event preceding a second liability event may indicate that the first liability event may cause (or otherwise increase a likelihood of) the second liability event to occur. Other ways of chaining together liability events within causal timelines that are consistent with this disclosure are also used in other examples.

Once controller 110 generates causal timelines (e.g., as described below with respect to FIGS. 2A and 2B), controller 110 may determine one or more liability events to exclude. In some examples, where some liability events are on more than one causal timeline, controller 110 may determine to “globally” remove a liability event (e.g., remove it from all causal timelines), whereas in other examples, controller 110 may remove single instances of a liability event. Controller 110 may remove one or more instances of one or more liability events in response to controller 110 determining that these (one or more instances of one or more) liability events are relatively unlikely to impact an economic liability of asset 130.

For example, controller 110 may include timeline thresholds, and may exclude some types of liability events that happened a threshold amount of time in the past. Controller 110 may utilize different timeline thresholds for different kinds of liability events, as different liability events may be determined to be likely to impact an economic liability of asset 130 for a relatively longer duration. For example, if a liability event relates to borrower of asset 130 (e.g., a business that is behind a loan of asset 130), controller 110 may utilize a relatively shorter time threshold (e.g., within the last 5 years), as borrowers may tend to change over time. Conversely, if a liability event relates to something that is more static and unchanging such as a natural weather phenomenon at a location that relates to asset 130 (e.g., an F4 level tornado that occurred seven years ago within a zip code associated with asset 130), controller 110 may utilize a relatively longer time threshold (e.g., within the last 15 years) to reflect a more static nature of this type of liability event.

Alternatively, or additionally, controller 110 may include timeline thresholds, and may exclude some types of liability events that are predicted to potentially happen a threshold amount of time in the future. As discussed above, controller 110 may utilize different timeline thresholds for different kinds of liability events, as different liability events may be more certain to happen. For example, if a liability event relates to a currently predicted specific weather event that may impact asset 130 (e.g., a tropical storm that has a chance of overlapping with a route of shipping voyage of asset 130), controller 110 may utilize a relatively shorter time threshold (e.g., within the upcoming 10 days), as borrowers may tend to change over time. Conversely, if a liability event relates to something that is more static and unchanging such as a planned geopolitical event (e.g., a simulation by a navy that is adjacent or overlapping a shipping lane), controller 110 may utilize a relatively longer time threshold (e.g., within the upcoming six months) to reflect a more static nature of this type of liability event.

Controller 110 may also utilize other types of criteria to determine to exclude a liability event. In some situations, controller 110 may determine to exclude some number of liability events in response to determining that a certain number of these liability events are all different permutations of a single variable. Moreover, controller 110 may determine that values of this single variable are arranged to a normal statistical distribution without a substantially widespread range (e.g., all of the liability events have a single variable that is within a standard deviation of an expected average value), and/or controller 110 may determine that the liability events that relate to this single variable include impacts that vary less than a threshold amount (e.g., such that each of the individual liability events of the group are predicted to have between a 10 to 15% impact).

For example, controller 110 may determine that a generated polynomial lattice of liability events includes scores or hundreds of different liability events related to different potential future interest rates relating to asset 130, where the different interest rates are distributed within the generated polynomial lattice according to a normal distribution. While each given potential future interest rate may have more than a threshold amount of impact, in the cumulative this group of liability events may have a relatively low impact in comparison to how large their size is, therein substantially increasing an amount of processing power needed to execute the analysis. In this example, controller 110 may determine that this group of liability events that relate to a single variable exceed a threshold number of liability events, and may therein select a subset of liability events of this group that approximate a reasonable spread of liability events within this group. For example, if controller 110 determine that the analysis includes scores of liability events of a group that relates to different interest rates between 5% and 10% (where values rise from 5.0, to 5.1, to 5.2, to 5.3, etc.), controller 110 may determine to keep a subset of liability events that approximates this preliminary spread (e.g., such that final values are kept of 5.0, 6.0, 7,0, 8.0, 9.0, and 10.0, with other non-whole numbers excluded).

In some examples, controller 110 may execute clustering techniques as known in the art to determine which types of liability events impact a liability of asset 130 more or less. Controller 110 may receive and/or identify a threshold amount of impact of liability events that a user or organization wants to include within a liability analysis. As would be understood by one of ordinary skill in the art, increasing the number of liability events that are included in an analysis may increase an accuracy of an analysis while simultaneously increasing an amount of time that the analysis takes and also increasing an amount of processing power that the analysis takes.

In some examples, controller 110 may include an initializing process of analyzing liability of asset 130 in order to determine whether to acquire and/or how to strategize for asset 130, where in this initializing process relatively more liability events are included (e.g., such that an analysis may be more accurate, while also being potentially slower and more resource-intensive). For example, controller 110 may have a higher standard for excluding liability events in this initializing process, such that, e.g., liability events are included if they meet at threshold impact of at least 5% impact to a liability of asset 130. Subsequent to this initializing process, controller 110 may be configured to periodically re-analyze a liability of asset 130 when accounting for relatively less liability events. For example, controller 110 may have a lower standard for excluding liability events in this periodic re-analysis process, such that, e.g., liability events are included if they meet a threshold impact of at least 10% impact to a liability of asset 130.

Once controller 110 has determined a set of causal timelines of asset 130 to analyze, controller 110 may evaluate a liability of various causal timelines by evaluating an interplay of liability events as described herein. For example, controller 110 may compare causal timelines of asset 130 against causal timelines 122 of assets 124 of corpus 120. Controller 110 may use a neural network and/or unsupervised clustering techniques to compare and/or match a generated polynomial lattice of liability events to liability events of causal timelines 122 of corpus 120. Each causal timeline 122 of corpus 120 may be associated with a respective historical asset 124. In some examples, controller 110 may also compare liability events of asset 130 to assets 124 of corpus. In other examples, controller 110 may identify a pool of assets 124 (and associated causal timelines 122) within corpus 120 that are relatively similar to asset 130, after which controller 110 may compare the causal timelines 122 within this pool to the generated and modified causal timeline

Controller 110 may access such repositories 140 and corpus 120 over network 150. Network 150 may include a computing network over which computing messages and/or computing data may be sent and/or received. For example, network 150 may include the Internet, a local area network (LAN), a wide area network (WAN), a wireless network such as a wireless LAN (WLAN), or the like. Network 150 may comprise copper transmission cables, optical transmission fibers, wireless transmission, routers, firewalls, switches, gateway computers and/or edge servers. A network adapter card or network interface in each computing/processing device (e.g., controller 110, corpus 120, and/or repositories 140) may receive messages and/or instructions from and/or through network 150 and forward the messages and/or instructions for storage or execution or the like to a respective memory or processor of the respective computing/processing device.

Though network 150 is depicted as a single entity in FIG. 1 for purposes of illustration, in other examples network 150 may include a plurality of private or public networks. For example, controller 110 and corpus 120 may communicate together over a private LAN of network 150 (e.g., as these two may be part of an organization that provides risk analysis capabilities for users). For another example, controller 110 may receive information from/regarding asset 130 through a coupling to a separate private WLAN that corresponds to respective assets 130 (e.g., where a business user sends a request regarding asset 130 to controller 110 from a private WLAN of the business over network 150). Additionally, controller 110 may gather data related to users from repositories 140 over a public portion of network 150 using the Internet.

FIGS. 2A and 2B depict conceptual diagrams of example polynomial lattices 160A, 160B (collectively, “polynomial lattices 160) that controller 110 may generate. Controller 110 may organize polynomial lattices 160 such that each liability event is a node that is connected to other nodes by edges that combine to make branches. In some examples, a location on a branch may indicate passages of time, where a location further down a branch indicates that the node (and therein the respective liability event) occurred further in the past or is predicted to occur further into the future.

The number and arrangement of nodes, edges, and branches as depicted in FIGS. 2A and 2B are presented for purposes of illustration only, as any arrangement of liability events into causal chains consistent with this disclosure is contemplated. Further, though the nodes of FIGS. 2A and 2B are depicted as static (e.g., all substantially similar) in appearance, in other examples the nodes of FIGS. 2A and 2B may change to reflect different data of the respective liability events. For example, nodes may be different colors to reflect when they did or are projected to occur, what type of liability event they were, a magnitude of the liability event (e.g., a severity of a tornado, or a size of a debt, or an amount of cargo of a shipping venture), or the like. In such examples, controller 110 may graphically compare causal timelines of polynomial lattices 160 to causal timelines 122 of corpus 120 in order to analyze a liability of asset 130 as described herein. In other examples, some or all such data is stored in a non-graphical format, such that controller 110 compares numbers, charts, comma-separated value (CSV) data, or the like of casual timelines of polynomial lattices 160 to historical causal timelines 122 of corpus to analyze a liability of asset 130.

For example, controller 110 may generate polynomial lattice 160A with nodes 170A-170EE (collectively referred to herein as “nodes 170”). Nodes 170 may each relate to a specific liability event and may be connected together via edges 172 that chain liability events of nodes 170 together into causal timelines. Nodes 170 and edges 172 may combine together to make branches, such as a large branch that includes nodes 170B-1700, subbranch 170C-1700, further subbranch 170F-170K, etc.

Polynomial lattice 160A may include both future and past events. For example, the branch that includes nodes 170B-1700 may relate to past events, while the branch that includes nodes 170P-170EE may relate to future events. In this example, node 170A may relate to the present, or asset 130, or something else. In some example, nodes 170 of a branch may all relate to similar types of liability event. For example, though only two nodes 170B, 170C branch from the originating node 170A in FIG. 2A for purposes of illustration, in some examples each node 170 that branches off from the originating node 170A may relate to a separate type of liability event (e.g., one branch for weather events, one branch for geopolitical events, one branch for debt-to-income events, etc.).

Branches may represent causal timelines, where, e.g., going further “down” the branches represents going further away from the present (e.g., whether going further back into the past or going further forward into the future). In this way, the liability event of node 170B may have been caused by or otherwise have happened more recently than the liability event of node 170C, which may have been caused by or otherwise have happened more recently than the liability events of nodes 170D, 170M, etc.

Controller 110 may identify a group of liability events that have less than a threshold impact to a liability of asset 130. For example, controller 110 may identify that liability events that correspond to node 170D and 170AA have less than a threshold impact to the economic liability of asset 130. In response to this determination, controller 110 may remove these nodes 170D, 170AA from the analysis of liability of asset 130. Controller 110 may also remove some or all nodes 170 that are only attached to the present via causal timelines of these nodes 170D, 170AA. For example, in excluding node 170D, controller 110 may also exclude 170E-170L in a subsequent analysis, and in excluding node 170AA, controller 110 may also exclude 170BB-170EE.

In this way, if controller 110 identifies that a liability event of node 170D had less than a threshold amount of impact to a liability of asset 130, controller 110 may determine that it is also safe to determine that other liability events preceded by the liability event of node 170D and/or caused the liability event of node 170D may also have less than a threshold amount of impact. As described above, such an effect may be magnified where each branch relates to a specific type or category of liability event. As such, as depicted in FIG. 2A, controller 110 may organize liability events into causal chains in which nodes 170 that are further “up” the respective branch (e.g., closer to an originating node 170A indicate a liability event with relatively more impact than respective nodes 170 which are further “down” the respective branch (e.g., further back in time or further forward into the future). By organizing liability events into such causal chains, when controller 110 identifies some liability events to exclude, controller 110 may safely identify that liability events that are “down” a branch of these liability events may also be excluded, magnifying an ability of controller 110 to analyze a liability of asset 130 relatively more quickly and less resource-intensive than conventional methods that may attempt to analyze or account for all liability events (and/or may only exclude liability events individually, rather than as part of pruning a whole branch).

Once controller 110 “prunes” polynomial lattice 160, controller 110 may analyze liability events to determine a liability of asset 130. For example, controller 110 may analyze remaining liability events (e.g., liability events that were not excluded) for a total economic liability of asset 130. Controller 110 may evaluate a total economic liability asset 130 by generating a liability score for each of nodes 170 of polynomial lattice 160A, and then weighing each of these liability scores together to determine a total score that accounts for every single liability event remaining. For example, controller 110 may weigh some nodes 170 that are determined to be more likely to happen higher, controller 110 may impact some nodes 170 that are determined to have a bigger impact on liability higher, or the like.

In other examples, controller 110 may generate polynomial lattices 160 where all branches share a common originating node and ending node, such as where asset 130 is a potential future shipping voyage and controller 110 is planning a route for this shipping voyage. For example, FIG. 2B depicts polynomial lattice 160B with liability events depicted as nodes 180A-180HH (hereinafter referred to as “nodes 180”). Nodes 180 may be connected via edges 182 and may combine to make branches. Polynomial lattice 160B, nodes 180, edges 182, and branches may all be substantially similar to polynomial lattice 160A, nodes 170, edges 172, and branches.

Controller 110 may analyze polynomial lattice 160B to identify a causal timeline with a least amount of economic liability. For example, controller 110 may analyze polynomial lattice 160B to identify a path from originating node 180A to terminating node 180HH, where each unique path from originating node 180A to terminating node 180HH indicates a unique causal timeline. Each of these unique causal timelines may be individually compared to causal timelines 122 of corpus 120 to identify which has the least amount of economic liability, such that this unique causal timeline is suggested by controller 110 as the plan of action (e.g., a route of a shipping trip, where asset 130 is a shipping voyage).

In some examples, controller 110 may cut branches from polynomial lattice 160B similar to with polynomial lattice 160A. For example, in response to identifying that a liability event of node 180W is low-impact, controller 110 may determine to exclude each of nodes 180W-180Y to completely remove this branch. Additionally, or alternatively, controller 110 may remove liability events but not remove branches where polynomial lattice 160B is an option of routes between originating node 180A and terminating node 180HH. For example, in response to identifying that a liability event of node 180B is below a threshold impact (e.g., is low-impact), controller 110 may exclude this node and cause edge 182 to directly connect originating node 180A and node 180C.

As described above, controller 110 may include a computing device with a processor configured to execute instructions stored on a memory to execute the techniques described herein. For example, FIG. 3 is a conceptual box diagram of such computing device 200 of controller 110. While computing device 200 is depicted as a single entity (e.g., within a single housing) for the purposes of illustration, in other examples, controller 110 may be stored within computing device 200 that includes two or more discrete physical systems (e.g., within two or more discrete housings). Computing device 200 may include interfaces 210, processor 220, and memory 230. Computing device 200 may include any number or amount of interface(s) 210, processor(s) 220, and/or memory(s) 230.

Computing device 200 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with corpus 120, a computing device sending information on asset 130, repositories 140, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to determine liabilities relating to various liability events of asset 130 via various causal timelines that exclude some liability events. Controller 110 may utilize processor 220 to determine liabilities in this way. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to evaluate liabilities relating to asset 130 via causal timelines of liability events.

Processor 220 may determine which liability events of asset 130 to disregard in order to reduce a total size and number of causal timelines that may need to be analyzed (e.g., compared to causal timelines 122 of corpus 120) to determine liabilities of asset 130 according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may analyze liabilities of asset 130 according to instructions 232 of one or more applications (e.g., software applications) stored in memory 230 of controller 110.

In addition to instructions 232, in some examples gathered or predetermined data or techniques or the like as used by processor 220 to analyze liabilities of asset 130 may be stored within memory 230. For example, memory 230 may include liability data 234 on asset 130 as received and/or gathered by controller 110, and/or memory 230 may include substantially all of historical causal timelines 122 and asset 124 data stored in corpus 120. Specifically, as depicted in FIG. 3, memory 230 may include liability data 234, which includes causal timeline data 236 and event data 238. Causal timeline data 236 may include both causal timeline data of asset 130 and historical causal timelines 122. Causal timeline data 234 may include the structure of polynomial lattices 160 while event data 238 includes data regarding a likelihood, nature, and/or magnitude of respective events.

Memory 230 may include preference and threshold data 242. For example, preference and threshold data 242 may include data such as risk tolerances of a user, and a threshold that reflects this risk tolerances. Preference and threshold data 242 may also reflect a general value or type of asset 130 that a user is interested in.

Memory 230 may further include machine learning techniques 240 that controller 110 may use to improve over time. For example, controller 110 may improve a process of determining which liability events are low impact over time. For another example, controller 110 may use machine learning techniques 240 to learn how to better cluster together liability events of a similar type into a single branch, such that removing one liability event of the branch that is determined to be low impact is more likely to result in an accurate exclusion of other liability events that are similarly low-impact.

Machine learning techniques 240 can comprise algorithms or models that are generated by performing supervised, unsupervised, or semi-supervised training on a dataset, and subsequently applying the generated algorithm or model to determine one or more liability events to discard and therein determined subsequent liability scores of causal timelines of asset 130 according to preference and threshold data 242. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Memory 230 may include NLP techniques 244 that controller 110 may use to identify whether data stored in repositories 140 include events that impact a liability and/or value of asset 130. NLP techniques 244 can include, but are not limited to, semantic similarity, syntactic analysis, and ontological matching. For example, in some embodiments, processor 220 may be configured to parse comments from a news source or the like in repositories 140 to determine semantic features (e.g., word meanings, repeated words, keywords, etc.) and/or syntactic features (e.g., word structure, location of semantic features in headings, title, etc.) of weather data or other types of natural event in an environment of asset 130. Ontological matching could be used to map semantic and/or syntactic features to a particular event that may impact liability. The concept can then be used to determine the subject matter. In this way, using NLP techniques 244, controller 110 may, e.g., identify publicly available event data that impacts a liability of asset 130 and/or determine the likelihood of such liability events impacting the economic liability.

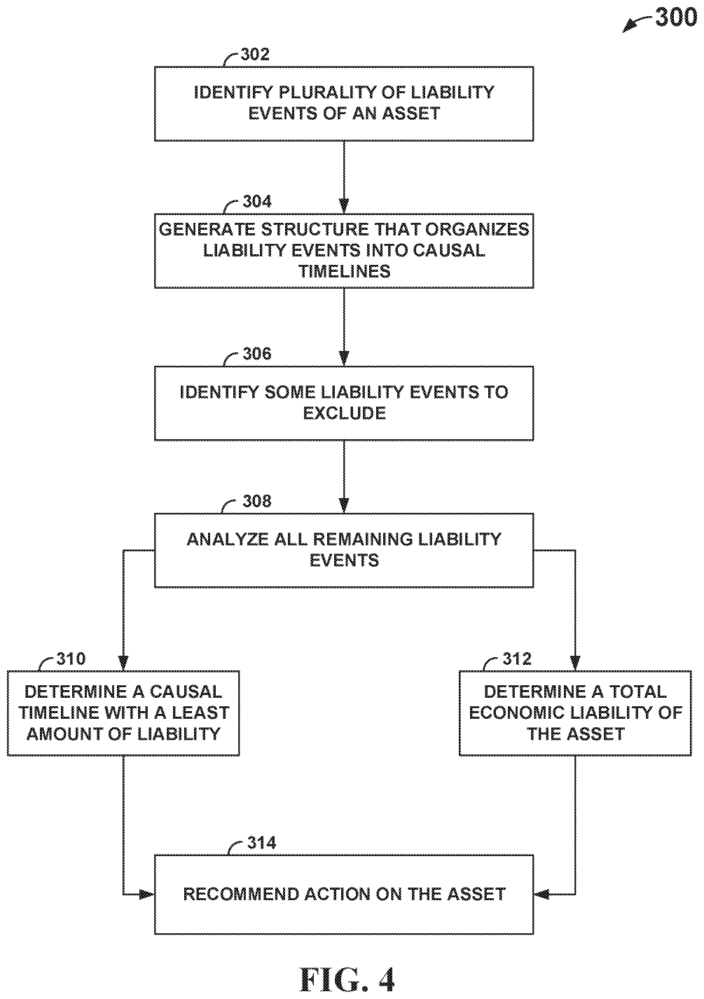

Using these components, controller 110 may evaluate a liability of asset 130 regarding various liability events by determining a subset of liability events to analyze as discussed herein. For example, controller 110 may analyze a subset of liability events according to flowchart 300 depicted in FIG. 4. Flowchart 300 of FIG. 4 is discussed with relation to FIG. 1 for purposes of illustration, though it is to be understood that other systems may be used to execute flowchart 300 of FIG. 4 in other examples. Further, in some examples controller 110 may evaluate liability differently than flowchart 300 of FIG. 4, or controller 110 may evaluate liability via a similar method with more or less steps in a different order, or the like.

Flowchart 300 begins with controller 110 identifying a plurality of liability events of asset 130 (302). These liability events may be events that impact an economic liability of asset 130. For example, asset 130 may be a CDO or the like, where liability events may relate to borrowers of asset 130 (e.g., different amounts of debt or income that are assigned to asset 130 at different times), or asset 130 may relate to a physical structure where liability events relate to natural events (e.g., tornados, hail storms, etc.) that may reduce a value of asset 130, or asset 130 may relate to a shipping voyage or the like where liability events relate to different routes or potential events. Controller 110 may identify and/or quantify these liability events as received from a user over network 150, and/or controller 110 may identify and/or quantify these liability events by crawling through one or more repositories 140 as described herein.

Controller 110 generates a structure that organizes the identified liability events into causal timelines (304). For example, controller 110 may generate a structure in which each liability event is a different element that is organized together to form branches that indicate causal timelines, where branches flow outward in a uniform manner to indicate time progressing (e.g., time progressing back into the past or time progressing forward into the future). Controller 110 may generate a structure such that liability events of a similar type (e.g., where a first type is weather, and a second type is a geopolitical event, etc.) are clustered together into shared branches (e.g., such that each branch only includes one type of liability event). Controller 110 may generate a structure similar to polynomial lattices 160 that includes liability events represented by nodes 170, 180 as connected by edges 172, 182, to chain together into branches that represent causal timelines, though other structures consistent with this disclosure are also possible.

Controller 110 identifies some liability events to exclude from an analysis (306). Controller 110 may analyze each liability event to determine whether each liability event satisfies a threshold amount of predicted impact, excluding liability events that are lower than the threshold. Put differently, controller 110 may identify some liability events that are not worth evaluating as they are not likely to impact an eventual liability of asset enough to warrant the computing resources (e.g., processing power or time) that would be used to analyze these liability events. For example, controller 110 may determine that a liability event does not satisfy a threshold as this liability event is too unlikely to happen (e.g., where events are only considered if they have at least a 10% likelihood), or controller 110 may determine that a liability event was so far in the past that a remaining amount of liability is minimal, or the like. In some examples, when controller 110 determines that a liability event of a branch is lower than a threshold, controller 110 may further determine to exclude that liability event as well as other liability events that are further down the branch (e.g., further back in the past, or further into the future) of that identified liability event.

Controller 110 analyzes the remaining liability events (308). For example, controller 110 may determine an economic liability of each liability event as a component of the remaining structure of liability events. For example, where asset 130 is a shipping voyage and controller 110 generates polynomial lattice 160B, each unique branch of polynomial lattice 160 may indicate a possible shipping route, such that controller 110 evaluates each branch in isolation as compared to each other. For another example, where asset 130 is a thing that can be acquired and controller 110 generates polynomial lattice 160A, each branch may include a separate factor (e.g., various amounts of income over time) that is cumulative to impact a total economic liability of asset 130. In analyzing liability, controller 110 may ignore branches of polynomial lattices 160 that were started by liability events that were excluded as discussed herein.

Controller 110 may determine a causal timeline with a least amount of liability (310). For example, where asset 130 is a shipping voyage, controller 110 may determine a branch of polynomial lattice 160 that includes relatively less liability over time. For example, where controller 110 generated polynomial lattice 160B, controller 110 may identify which path from node 180A to node 180HH that includes the least amount of economic liability by adding individual liability of each liability event of respective nodes 180. Controller 110 may compare nodes 180 and edges 182 that create causal timelines against causal timelines 122 of corpus to determine respective individual liability scores. Conversely, controller 110 may determine a total economic liability of asset 130 (312). Determining a total economic liability of asset 130 may include determining an economic liability of each branch of polynomial lattice 160 and factoring all branches together into a single liability score. For example, controller 110 may determine a liability score for each individual liability event, where this liability score indicates how a total liability of asset 130 is impacted and/or would be impacted if this liability event occurs, occurs in a certain way, occurs in conjunction with other liability events, or the like. The liability scores of liability events (which may be represented as nodes) and/or the cumulative liability scores of branches of nodes may be individually weighed to predict “worth” of those liability events (e.g., where a higher weight indicates a higher impact to a total liability). Upon being individually weighed, controller 110 may combine these branches and nodes according to these weights to determine a predicted total liability. Controller 110 may compare these branches against historical causal timelines 122 to weigh these branches and nodes.

Controller 110 may recommend an action on asset 130 (314). For example, controller 110 may determine whether or not risk score is above or below a threshold of a user that relates to acquiring asset 130. For another example, where controller 110 received a request regarding planning a future strategy for asset 130, controller 110 may recommend an action with a causal timeline with a least amount of economic liability to a user. Controller 110 may provide this recommendation on a user interface used by user. This recommendation may include a specific plan of action, such as a charted course, or a recommendation to acquire/invest in asset 130. In some examples, this recommendation may indicate what liability events were most impactful in determining the economic liability. By providing a recommendation and also providing the most indicative liability events, controller 110 may enable a user to quickly decide whether or not and/or how to take an action for asset 130. Further, by excluding certain nodes and branches, the method of 300 improves performance of controller 110 by reducing the amount of time and/or resources required to compute and output the recommendation.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a plurality of liability events of an asset, wherein the plurality of liability events impacts an economic liability of the asset and different subsets of the plurality of liability events chain together in different causal timelines of the asset;
identifying a group of the plurality of liability events to exclude from analysis based on a likelihood of the group of liability events impacting the economic liability being lower than a threshold;
analyzing remaining liability events; and
identifying, from the analysis, a causal timeline of liability events that has a least amount of economic liability.

2. The computer-implemented method of claim 1, further comprising:
identifying, from the analysis, liability scores of each of the different causal timelines of the asset that do not include the group of liability events; and
determining, by weighing each of the liability scores, a total economic liability of the asset.

3. The computer-implemented method of claim 1, further comprising generating a polynomial lattice of the plurality of liability events to reflect the different causal timelines.

4. The computer-implemented method of claim 3, wherein the analysis includes removing a branch of the polynomial lattice that starts with one of the group of liability events.

5. The computer-implemented method of claim 4, wherein every liability event of the branch is of a same type of liability event.

6. The computer-implemented method of claim 1, wherein the identifying the group of liability events includes identifying that each of the group of liability events relates to a single variable.

7. The computer-implemented method of claim 6, wherein the analysis includes analyzing a subset of liability events that relates to the single variable to approximate a spread of the single variable within the analysis.

8. The computer-implemented method of claim 1, wherein the asset is a shipping voyage and the causal timelines includes a route of the shipping voyage.

9. The computer-implemented method of claim 1, further comprising determining whether or not a liability score of the causal timelines satisfies a pre-determined risk threshold that corresponds to a value of the asset.

10. The computer-implemented method of claim 9, further comprising providing a recommendation to a user via a user interface in response to the liability score satisfying the pre-determined risk threshold.

11. A system comprising:
a processor; and
a memory in communication with the processor, the memory containing instructions that, when executed by the processor, cause the processor to:
identify a plurality of liability events of an asset, wherein the plurality of liability events impacts an economic liability of the asset and different subsets of the plurality of liability events chain together in different causal timelines of the asset;
identify a group of liability events to exclude from analysis based on a likelihood of the group of liability events impacting the economic liability being lower than a threshold;
analyze remaining liability events; and
identify, from the analysis, a causal timeline of liability events that has a least amount of economic liability.

12. The system of claim 11, the memory containing additional instructions that, when executed by the processor, cause the processor to:
identify, from the analysis, liability scores of each of the different causal timelines of the asset that do not include the group of liability events; and
determine, by weighing each of the liability scores, a total economic liability of the asset.

13. The system of claim 11, the memory containing additional instructions that, when executed by the processor, cause the processor to generate a polynomial lattice of the plurality of liability events to reflect the different causal timelines.

14. The system of claim 13, wherein the analysis includes removing a branch of the polynomial lattice that starts with one of the group of liability events.

15. The system of claim 13, wherein every liability event of the branch is of a same type of liability event.

16. The system of claim 11, wherein the identifying the group of liability events includes identifying that each of the group of liability events relates to a single variable, and the analysis includes analyzing a subset of liability events that relates to the single variable to approximate a spread of the single variable within the analysis.

17. The system of claim 11, wherein the asset is a shipping voyage and the causal timeline includes a route of the shipping voyage.

18. The system method of claim 11, the memory containing additional instructions that, when executed by the processor, cause the processor to:
determine whether or not a liability score of the causal timeline satisfies a pre-determined risk threshold that corresponds to a value of the asset; and
provide a recommendation to a user via a user interface in response to the liability score satisfying the pre-determined risk threshold.

19. A computer program product, the computer program product comprising a computer readable storage medium having program instructions embodied therewith, the program instructions executable by a computer to cause the computer to:
identify a plurality of liability events of an asset, wherein the plurality of liability events impacts an economic liability of the asset and different subsets of the plurality of liability events chain together in different causal timelines of the asset;
identify a group of liability events to exclude from analysis based on a likelihood of the group of liability events impacting the economic liability being lower than a threshold;
analyze remaining liability events; and
identify, from the analysis, a causal timeline of liability events that has a least amount of economic liability.

20. The computer program product of claim 19, the computer readable storage medium having additional program instructions that, when executed by the computer, cause the computer to:
identify, from the analysis, liability scores of each of the different causal timelines of the asset that do not include the group of liability events; and
determine, by weighing each of the liability scores, a total economic liability of the asset.
